(19) United States
(12) Patent Application Publication
(10) Pub. No.: US 2012/0173604 A1
(43) Pub. Date: Jul. 5, 2012

(54) DATA CENTER SYSTEM, RECONFIGURABLE NODE, RECONFIGURABLE NODE CONTROLLING METHOD AND RECONFIGURABLE NODE CONTROL PROGRAM

(75) Inventor: Hiroaki Inoue, Tokyo (JP)

(73) Assignee: NEC CORPORATION, Minato-ku, Tokyo (JP)

(21) Appl. No.: 13/395,725

(22) PCT Filed: Sep. 13, 2010
(86) PCT No.: PCT/JP2010/065704

§ 371 Date: Mar. 13, 2012

(30) Foreign Application Priority Data
Sep. 18, 2009 (JP) 2009-216452

(51) Int. Cl. G06F 15/16

(52) U.S. Cl. 709/201

(57) ABSTRACT

A data center system, comprises a plurality of nodes, and a reconfigurable node which executes processing in response to a processing request from the plurality of nodes and which can be shared by the plurality of nodes. The reconfigurable node includes at least one server including at least one device which executes processing according to the processing request, and a control device which allocates, in response to a processing request from a calculation node and a communication node, processing corresponding to the processing request to the device of the server.

### TECHNICAL FIELD

The present invention relates to a data center system, a reconfigurable node, a reconfigurable node controlling method and a reconfigurable node control program and, more particularly, a data center system which enables processing of a communication node and a calculation node to be shared by using a reconfigurable node, a reconfigurable node, a reconfigurable node controlling method and a reconfigurable node control program thereof.

### BACKGROUND ART

In a data center having a calculation node and a communication node, a semiconductor integrated circuit required for configuring each node is expected to comprise a plurality of CPUs (Central Processing Unit) and a plurality of reconfigurable devices. Technique of a data center comprising a calculation node and a communication node is disclosed in, for example, Patent Literature 1 and Patent Literature 2.

Data centers in the techniques disclosed in the Patent Literature 1 and the Patent Literature 2 both comprise a communication node formed of a router or the like and a calculation node formed of a server or the like.

One example of a data center adapting the related art recited in the Patent Literature 1 and the Patent Literature 2 is here shown in FIG. 9.

With reference to FIG. 9, a calculation node 11 comprises servers 111S1 through 111Sn and a communication node 21 comprises routers 211R1 through 211Rm.

The communication node 21 appropriately distributes a request having arrived from outside and sends the same to each server of the calculation node 11, so that each server of the calculation node 11 executes processing to send a processing result in question as a response.

FIG. 10 is a diagram showing a full-featured semiconductor integrated circuit 31 for use in the calculation node 11 and the communication node 21 shown in FIG. 9.

With reference to FIG. 10, the full-featured semiconductor integrated circuit 31 comprises a plurality of CPUs 341C1 through 341Cj and a plurality of reconfigurable devices 342D1 through 342Di.

The reconfigurable device 342 here denotes a device whose hardware configuration can be freely changed by given configuration information, representative of which is an FPGA (Field Programmable Gate Array).

In general, the reconfigurable device 342 is used, when processing at the CPU 341 is too slow, for accelerating the processing. The reconfigurable device 342, however, needs not be used if the processing at the CPU 341 can be executed fast enough. In other words, the number of the reconfigurable devices 342 required in the full-featured semiconductor integrated circuit 31 will largely vary according to the processing at the CPU 341.

In the calculation node 11 and the communication node 21, the server 111 and the router 211 each use one or a plurality of the full-featured semiconductor integrated circuits 31.

With regard to the full-featured semiconductor integrated circuit 31, the router 211 may comprise the circuit in the communication node 21 or with a node configured which is commonly referred to by the router 211, the node may be provided with the circuit.

Such method of the related art shown in FIG. 9 and FIG. 10 has the following problem.

More specifically, in a case where loads of processing required in the calculation node 11 and the communication node 21 vary, a large number of reconfigurable devices not to be used will exist in each node, resulting in wasting costs.

Demanded is accordingly a mechanism of efficiently sharing reconfigurable devices in a calculation node and a communication node according to processing required.

One example of a technique of efficiently sharing a reconfigurable device is disclosed in Patent Literature 3, for example. The technique recited in the Patent Literature 3 realizes high efficiency and speed-up of function inspection by dividing a logic circuit into FPGA and allocating them.

Patent Literature 1: Japanese Patent Laying-Open No. 2008-021232

Patent Literature 2: Japanese Patent Laying-Open No. 2003-124976

Patent Literature 3: Japanese Patent Laying-Open No. H11-134385

As described above, the techniques recited in the Patent Literature 1 and the Patent Literature 2 have a problem, related to a data center having a semiconductor integrated circuit using a reconfigurable device, of difficulty in realizing the data center without wasting costs when loads of processing required in a calculation node and a communication node vary.

The technique recited in the Patent Literature 3, which is intended to divide a logic circuit so as to satisfy FPGA constraint conditions, has a problem that efficient allocation of FPGA is impossible according to processing.

### OBJECT OF THE PRESENT INVENTION

An object of the present invention is to provide a data center system, a reconfigurable node, a reconfigurable node controlling method and a reconfigurable node control program which solve the above-described problems.

### SUMMARY

According to a first exemplary aspect of the invention, a data center system includes a plurality of nodes, and a reconfigurable node which executes processing in response to a processing request from the plurality of nodes and which can be shared by the plurality of nodes, wherein the reconfigurable node includes at least one server including at least one device which executes processing according to the processing request, and a control device which allocates, in response to a processing request from a calculation node and a communication node, processing corresponding to the processing request to the device of the server.

According to a second exemplary aspect of the invention, a reconfigurable node of a data center system which is structured to be shared by a plurality of nodes of the data center system, includes at least one server including at least one device which executes processing according to a processing request from the plurality of nodes, and a control device which allocates, in response to a processing request from the plurality of nodes, processing corresponding to the processing request to the device of the server.

According to a third exemplary aspect of the invention, a reconfigurable node control method of a data center system, wherein in a data center system having a plurality of nodes, a reconfigurable node structured to be shared by the plurality of nodes and having at least one server including at least one device which executes processing in response to a processing request from the plurality of nodes
accepts a processing request from the plurality of nodes, and
allocates, in response to the processing request, processing corresponding to the processing request to the device of the server.

According to a fourth xemplary aspect of the invention, a computer-readable medium storing a program, wherein the program causes a reconfigurable node structured to be shared by a plurality of nodes of a data center system and having at least one server including at least one device which executes processing in response to a processing request from the plurality of nodes to execute the processing of:
accepting a processing request from the plurality of nodes; and
allocating, in response to the processing request, processing corresponding to the processing request to the device of the server.

The present invention enables reduction in the number of necessary reconfigurable devices, thereby realizing a data center system having a semiconductor integrated circuit using a reconfigurable device at low costs.

### BRIEF DESCRIPTION OF THE DRAWINGS

FIG. 1 is a block diagram showing a structure of a data center system according to a first exemplary embodiment of the present invention;

FIG. 2 is a block diagram showing a structure of a lightweight semiconductor integrated circuit according to the first exemplary embodiment of the present invention;

FIG. 3 is a block diagram showing a structure of a reconfigurable semiconductor integrated circuit according to the first exemplary embodiment of the present invention;

FIG. 4 is a block diagram showing a structure of a reconfigurable node control device according to the first exemplary embodiment of the present invention;

FIG. 5 is a diagram showing a structure of an allocation management table according to the first exemplary embodiment of the present invention;

FIG. 6 is a flow chart showing operation of the reconfigurable node control device at the time of reception of a processing request according to the first exemplary embodiment of the present invention;

FIG. 7 is a flow chart showing operation of the reconfigurable node control device at the time of reception of a release request according to the first exemplary embodiment of the present invention;

FIG. 8 is a block diagram showing an example of a hardware structure of a reconfigurable node control device of the present invention;

FIG. 9 is a diagram showing a structure of the related art; and

FIG. 10 is a diagram showing a structure of a semiconductor integrated circuit included in the related art.

### EXEMPLARY EMBODIMENT

Next, an exemplary embodiment of the present invention will be detailed with reference to the drawings.

### First Exemplary Embodiment

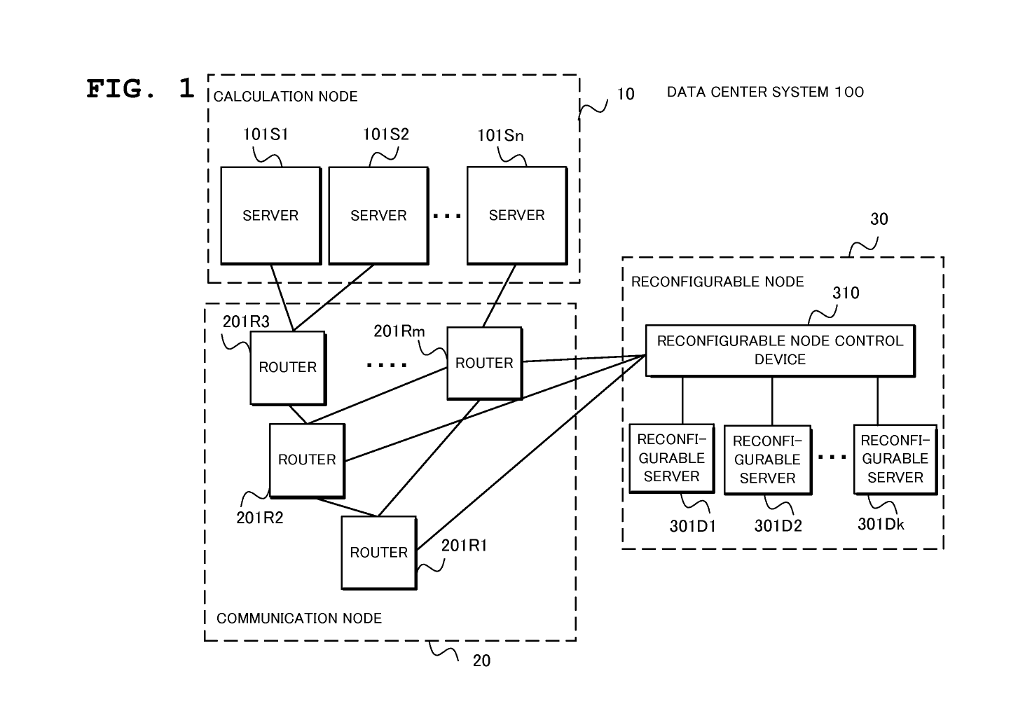

FIG. 1 is a diagram showing a structure of a data center system according to a first exemplary embodiment of the present invention.

With reference to FIG. 1, a data center system 100 according to the first exemplary embodiment of the present invention comprises a calculation node 10 which executes arithmetic operation processing, a communication node 20 which connects the outside and the calculation node 10, and a reconfigurable node 30, and the reconfigurable node 30 which executes processing in response to a request from the calculation node 10 and the communication node 20.

The calculation node 10 comprises servers 101S1 to 101Sn. The server 101 processes an external request sent from the communication node 20 and responds to the same. The number of the servers 101 is assumed to be at least one and to be unlimited.

The communication node 20 comprises routers 201R1 to 201Rn. The router 201 appropriately distributes requests arriving from outside and sends the same to the respective servers of the calculation node 10, as well as being used for the connection between the servers 101 and the reconfigurable node 30. The number of the routers 201 is assumed to be at least one and to be unlimited.

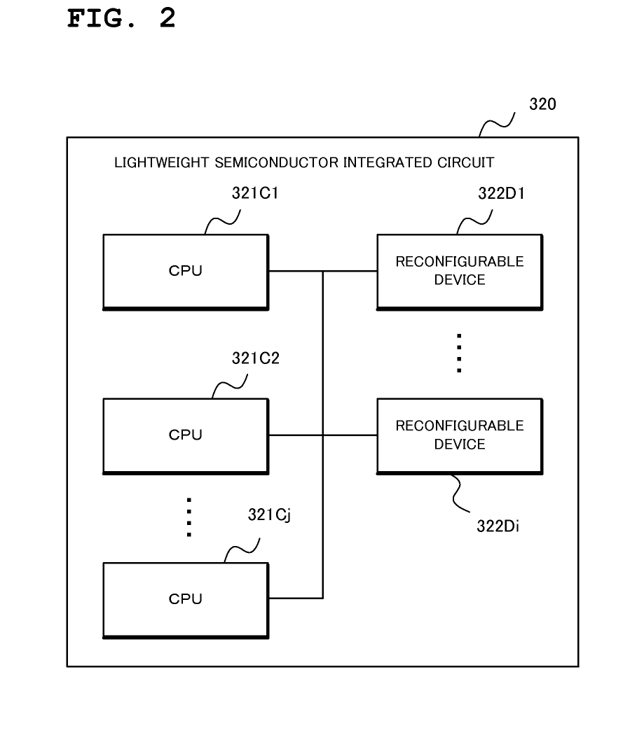

FIG. 2 here is a diagram showing a structure of a lightweight semiconductor integrated circuit 320 for use in each of the server 101 and the router 201.

The lightweight semiconductor integrated circuit 320 comprises a plurality of CPUs 321C1 to 321Cj and reconfigurable devices 322D1 to 322Di.

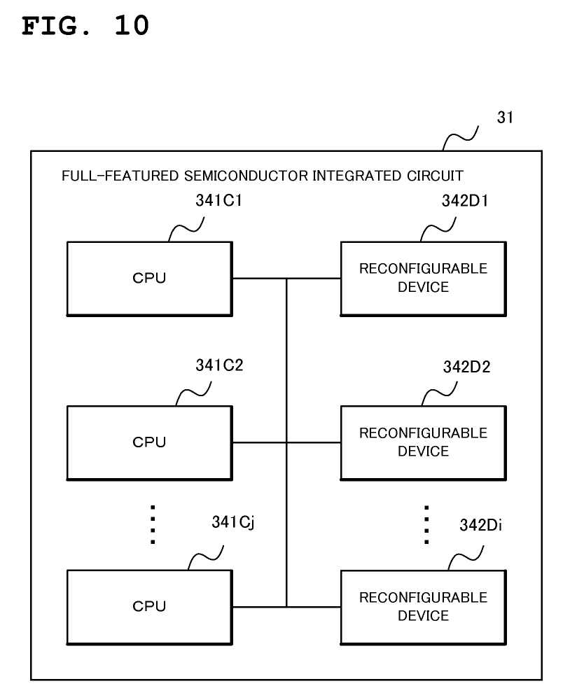

Here, the number of reconfigurable devices 322 included in the lightweight semiconductor integrated circuit 320 is less than the number of reconfigurable devices provided in a full-featured semiconductor integrated circuit 31 shown in FIG. 10 (as a matter of course, it can be null).

The reconfigurable device 322 may have its function reduced as compared with the reconfigurable device 342. This enables reduction in costs of the calculation node 10 and the communication node 20.

Here, the lightweight semiconductor integrated circuit 320 may be provided in the router 201 in the communication node 20 or may be provided in a node structured to be referred to in common by the routers 201.

The calculation node 10 and the communication node 20 use one or a plurality of lightweight semiconductor integrated circuits 320.

The reconfigurable node 30 comprises at least one reconfigurable node control device 310 and reconfigurable servers 301D1 to 301Dk. The number of reconfigurable servers 301 is assumed to be unlimited. The reconfigurable node 30 is used in common by the calculation node 10 and the communication node 20.

The reconfigurable server 301 comprises at least one reconfigurable device 331, which is for use in accelerating processing from the calculation node 10 and the communication node 20.

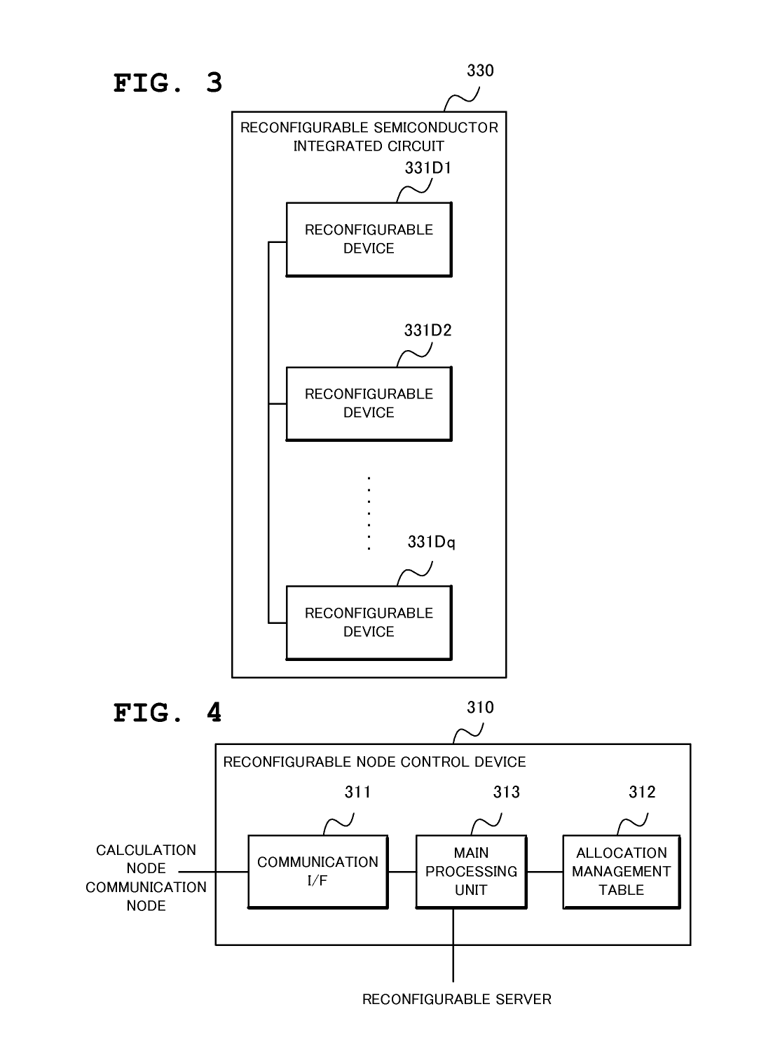

FIG. 3 is a diagram showing a structure of a reconfigurable semiconductor integrated circuit 330 for use in the reconfigurable server 301.

The reconfigurable semiconductor integrated circuit 330 comprises at least one of reconfigurable devices 331D1 to 331Dq. The reconfigurable semiconductor integrated circuit 330 is characterized in being a semiconductor integrated circuit comprising only the reconfigurable device 331.

The reconfigurable server 301 uses at least one reconfigurable semiconductor integrated circuit 330.

The reconfigurable node control device 310 allocates and releases the reconfigurable device 331 on a reconfigurable server basis or a reconfigurable device basis according to a request from the calculation node 10 and the communication node 20. A plurality of the reconfigurable node control devices 310 may be provided in the reconfigurable node 30.

Allocation and release of a reconfigurable device on a reconfigurable server basis is to execute allocation and release of all the reconfigurable devices that an arbitrary reconfigurable server comprises in response to a request.

FIG. 4 is a diagram showing a structure of the reconfigurable node control device 310.

The reconfigurable node control device 310 comprises a communication I/F 311, a main processing unit 313 and an allocation management table 312.

With the communication node 20, the communication I/F 311 receives a request and makes a response to the same from the calculation node 10 and the communication node 20. In addition, with the main processing unit 313, the communication I/F 311 transmits and receives the request and the response in question.

Based on a request transferred from the communication I/F 311, the main processing unit 313 executes allocation of the reconfigurable device 331 to necessary processing or release of the same with reference to the allocation management table 312.

A plurality of the reconfigurable devices 331 may be allocated to one processing. As an allocation/release algorithm, related art for allocating a reconfigurable device which has not been used recently may be used.

Furthermore, the main processing unit 313 transfers a processing request to the reconfigurable server 301 corresponding to the allocated reconfigurable device 331.

The main processing unit 313 also receives a processing result from the reconfigurable server 301 and transfers the same to the communication I/F 311.

The allocation management table 312 is a table that manages which reconfigurable device is used in which processing and is used by which calculation node and communication node.

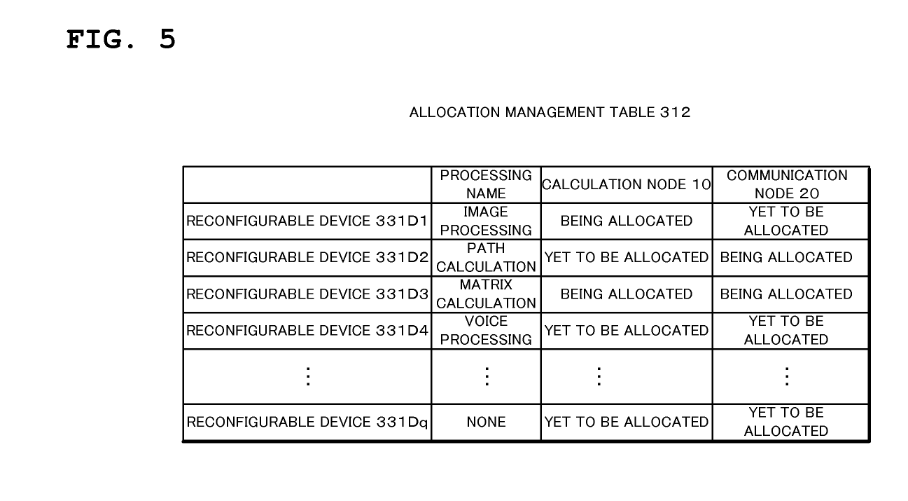

FIG. 5 is a diagram showing a structure of the allocation management table 312.

In the example shown in FIG. 5, a reconfigurable device 331D1 is used for image processing. Then, shown is that while the reconfigurable device 331D1 is used by all or a part of servers of the calculation node 10, it is not used by the communication node 20.

A reconfigurable device 331D2 is used in path calculation. Then, shown is that while the reconfigurable device 331D2 is not used by the calculation node 10 but used by all or a part of routers of the communication node 20.

A reconfigurable device 331D3 is used in matrix calculation. Then, shown is that while the reconfigurable device 331D3 is used by all or a part of the servers of the calculation node 10 and used by all or a part of the routers of the communication node 20. As shown in this example, not only allocation of a reconfigurable device according to loads but also common use of a reconfigurable device for the same processing contribute cost reduction.

A reconfigurable device 331D4 is used in voice processing. The reconfigurable device 331D4 is used neither by the calculation node 10 nor by the communication node 20. It is shown, however, that for future use, the voice processing itself is being configured. It can be newly configured into another processing as a matter of course.

A reconfigurable device 331Dq is not used for any processing and is accordingly used neither by the calculation node nor by the communication node.

State of being allocated or being yet to be allocated may be represented by a numerical value indicating that the number of the servers 101 or the routers 201 being allocated is not less than 0 or is 0. The calculation node 10 and the communication node 20 need not be managed separately. In any case, the allocation management table 312 can take any form as long as it is capable of managing which reconfigurable device 331 is configured into which processing and whether it is used by the server 101 or the router 201.

While the present exemplary embodiment has been described with respect to a structure in which all the requests and responses are made through the reconfigurable node control device 310, the calculation node 10 and the communication node 20 may directly transmit and receive processing to/from the reconfigurable server 301 after allocation as a matter of course.

When there are a plurality of reconfigurable node control devices 310, the allocation management table 312 may be provided in each reconfigurable node control device 310 or may be shared by all the reconfigurable node control devices 310.

### Description of Operation of the First Exemplary Embodiment

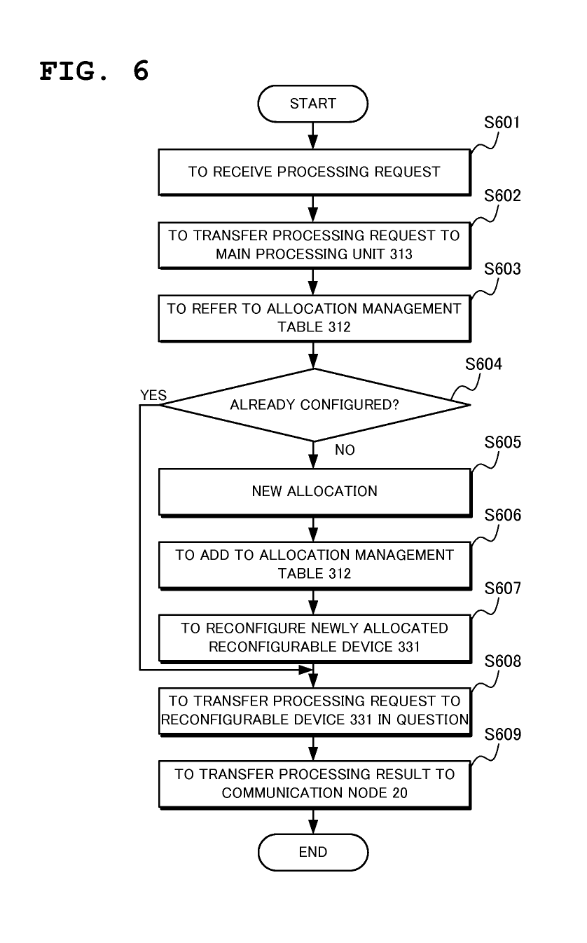

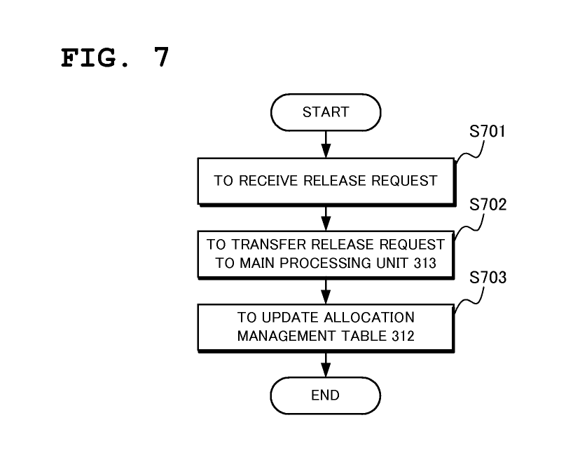

Next, with reference to FIG. 6 and FIG. 7, operation of the present exemplary embodiment will be detailed. FIG. 6 and FIG. 7 are diagrams showing operation of the reconfigurable node control device 310 according to the present exemplary embodiment.

### Description of Operation at Processing Request Reception

First, with reference to FIG. 6, description will be made of operation at processing request reception in the reconfigurable node control device 310. Since as to the processing request, those skilled in the art of the present invention could easily arrive at it and the processing request itself is not directly relevant to the present invention, no detailed description will be made thereof.

First, the communication I/F 311 receives from the communication node 20 a processing request to the reconfigurable device which request is from the server 101 of the calculation node 10 and the router 201 of the communication node 20 (Step S601).

Next, the communication I/F 311 transfers the received processing request to the main processing unit 313 (Step S602).

Upon receiving the processing request, the main processing unit 313 refers to the allocation management table 312 (Step S603) to check whether processing related to the processing request is being used by any of the reconfigurable devices 331 (Step S604).

When the processing related to the processing request is used by none of the reconfigurable devices 331 (“NO” at Step S604), the main processing unit 313 newly allocates the reconfigurable device 331 (Step S605) and adds the allocated information to the allocation management table 312 (Step S606).

When the processing related to the processing request is already used by any of the reconfigurable devices 331 (“YES” at Step S604), the main processing unit 313 transfers the processing request to the reconfigurable device 331 using the processing related to the processing request (Step S608).

Next, the main processing unit 313 reconfigures the newly allocated reconfigurable device 331 (Step S607). Configuration information required for reconfiguration is obtained by referring to configuration information existing in the data center. The configuration information may be referred to through the network or referred to from the storage device in the reconfigurable node control device 310.

Next, the main processing unit 313 transfers the processing request to the reconfigurable device 331 using the processing related to the processing request (Step S608). Next, upon receiving the processing result from the reconfigurable device 313 331, the main processing unit 313 sends the processing result to the communication I/F 311, so that the communication I/F 311 transfers the processing result to the communication node (Step S609).

### Description of Operation at Release Request Reception

Next, description will be made of operation to be executed upon release request reception at the reconfigurable node control device 310. Since as to the release request itself, those skilled in the art of the present invention could easily arrive at it and the release request itself is not directly relevant to the present invention, no detailed description will be made thereof.

First, the communication I/F 311 receives from the communication node 20 a release request to the reconfigurable device which request is from the server 101 of the calculation node 10 and the router 201 of the communication node 20 (Step S701).

Next, the communication I/F 311 transfers the received release request to the main processing unit 313 (Step S702).

Upon receiving the release request, the main processing unit 313 refers to the allocation management table 312 to add to the allocation management table 312 the recitation that allocation of the reconfigurable device 331 relevant to the release request is released (Step S703). More specifically, in the example shown in FIG. 3, allocation of the relevant reconfigurable device 331 is set to be “yet-to-be-allocated”.

While in the foregoing, the description has been made of a case where release is explicitly executed, release may not be necessarily executed as a matter of course. In a case where no release is executed, it is possible to cope with the case by arranging an algorithm, for example, to allocate the reconfigurable device 331 which has not be recently used.

### Effects of the First Exemplary Embodiment

Next, effects of the present exemplary embodiment will be described.

The present exemplary embodiment enables the number of necessary reconfigurable devices to be reduced by efficiently allocating reconfigurable devices according to processing.

This realizes a data center system having a semiconductor integrated circuit using a reconfigurable device at low costs.

In addition, the present exemplary embodiment enables expansion of a data center at low costs by adding a node formed of a reconfigurable device even when required processing will be increased in future.

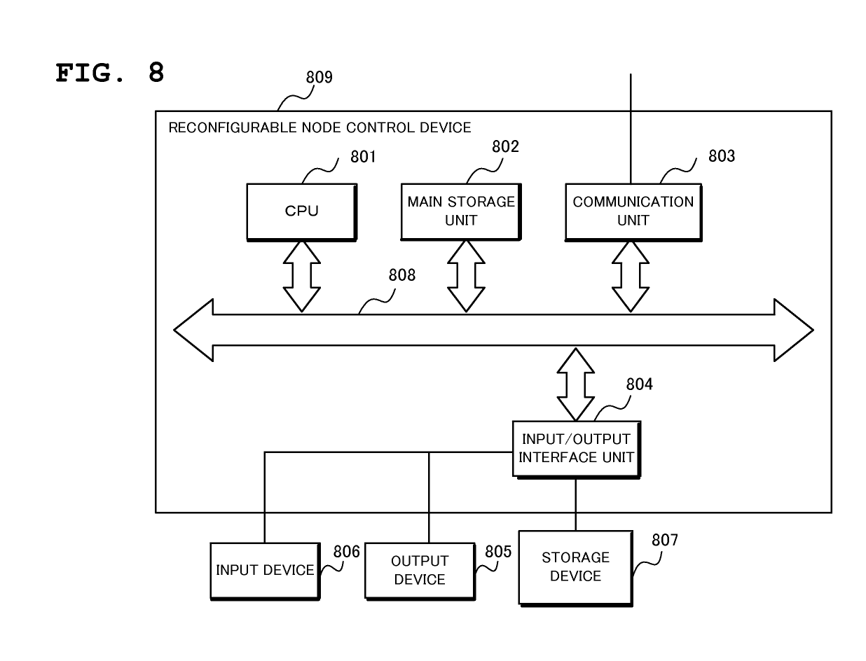

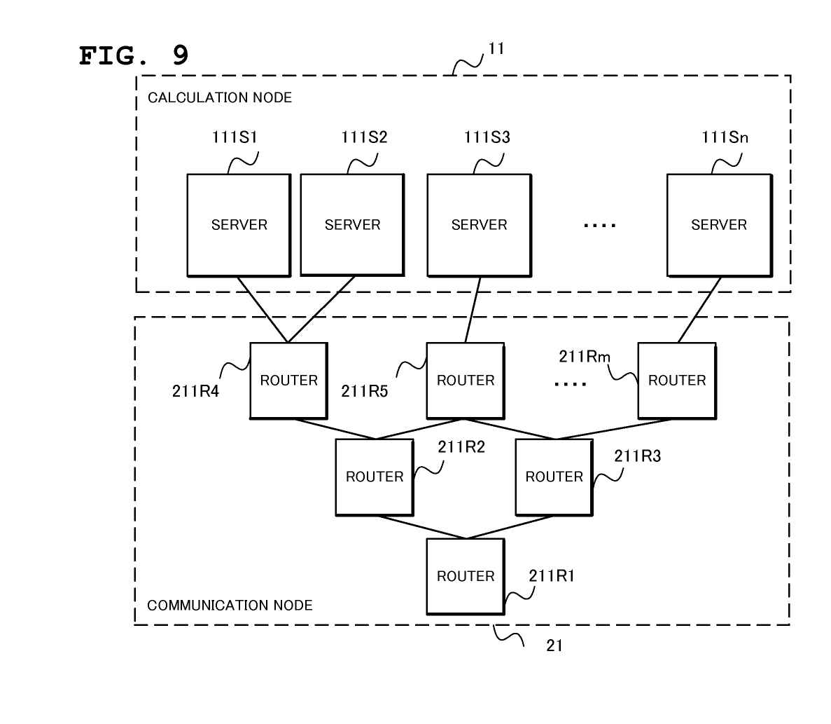

Next, description will be made of an example of a hardware structure of a reconfigurable node control device of the present invention with reference to FIG. 8. FIG. 8 is a block diagram showing an example of a hardware structure of a reconfigurable node control device 809 of the present invention.

With reference to FIG. 8, the reconfigurable node control device 809, which has the same hardware structure of a common computer device, comprises a CPU (Central Processing unit) 801, a main storage unit 802 formed of a memory such as a RAM (Random Access Memory) for use as a data working region or a data temporary saving region, a communication unit 803 which transmits and receives data through a network, an input/output interface unit 804 connected to an input device 805, an output device 806 and a storage device 807 to transmit and receive data, and a system bus 808 which connects each of the above-described components with each other. The storage device 807 is realized by a hard disk device formed of a non-volatile memory such as a ROM (Read Only Memory), a magnetic disk or a semiconductor memory.

The main processing unit 313 of the reconfigurable node control device 809 of the present invention has its operation realized not only in hardware by mounting a circuit part as a hardware part such as an LSI (Large Scale Integration) with a program incorporated but also in software by storing a program which provides their functions in the storage device 807, loading the program into the main storage unit 802 and executing the same by the CPU 801.

### INCORPORATION BY REFERENCE

This application is based upon and claims the benefit of priority from Japanese patent application No. 2009-216452, filed on Sep. 18, 2009, the disclosure of which is incorporated herein in its entirety by reference.

### INDUSTRIAL APPLICABILITY

The present invention is applicable to such a use of setting up a data center having a semiconductor integrated circuit using a reconfigurable device at low costs.

While the present invention has been described with respect to the preferred exemplary embodiment in the foregoing, such is for illustrative purpose only and it is not to be construed limitative. Modification and variation of the present invention will be obvious within the scope of its technical idea.

1. A data center system, comprising:
a plurality of nodes; and
a reconfigurable node which executes processing in response to a processing request from said plurality of nodes and which can be shared by said plurality of nodes, wherein said reconfigurable node includes,
at least one server including at least one device which executes processing according to said processing request, and
a control device which allocates, in response to a processing request from a calculation node and a communication node, processing corresponding to the processing request to said device of said server.

2. The data center system according to claim 1, wherein said control device allocates, to one said processing request, at least one said device which executes processing according to the processing request.

3. The data center system according to claim 2, wherein said control device allocates, to one said request, at least one said device which executes processing according to the processing request on said server basis.

4. The data center system according to claim 2, wherein said control device allocates, to one said request, the plurality of said devices which execute processing according to the processing request over the plurality of said servers.

5. The data center system according to claim 1, wherein said control device comprises an allocation management table which manages an allocation status of said device included in said server, and
refers to said allocation management table and when processing corresponding to said processing request is allocated to none of said devices, executes allocation of said device and when the processing in question is allocated to said device, transfers said processing request to the allocated device.

6. The data center system according to claim 5, wherein said control device adds information about said allocation to said allocation management table.

7. The data center system according to claim 5, wherein
said reconfigurable node comprises a plurality of said control devices, and wherein
said plurality of said control devices share said allocation management table.

8. The data center system according to claim 1, wherein said control device releases allocation of said device in response to a release request from said plurality of nodes.

9. A reconfigurable node of a data center system which is structured to be shared by a plurality of nodes of the data center system, comprising:
at least one server including at least one device which executes processing according to a processing request from said plurality of nodes; and
a control device which allocates, in response to a processing request from said plurality of nodes, processing corresponding to the processing request to said device of said server.

10. The reconfigurable node of the data center system according to claim 9, wherein said control device allocates, to one said processing request, at least one said device which executes processing according to the processing request.

11. The reconfigurable node of the data center system according to claim 10, wherein said control device allocates, to one said request, at least one said device which executes processing according to the processing request on said server basis.

12. The reconfigurable node of the data center system according to claim 10, wherein said control device allocates, to one said request, the plurality of said devices which execute processing according to the processing request over the plurality of said servers.

13. The reconfigurable node of the data center system according to claim 9, wherein said control device
comprises an allocation management table which manages an allocation status of said device included in said server, and
refers to said allocation management table and when processing corresponding to said processing request is allocated to none of said devices, executes allocation of said device and when the processing in question is allocated to said device, transfers said processing request to the allocated device.

14. The reconfigurable node of the data center system according to claim 13, wherein said control device adds information about said allocation to said allocation management table.

15. The reconfigurable node of the data center system according to claim 13, comprising a plurality of said control devices, wherein
the plurality of said control devices share said allocation management table.

16. The reconfigurable node of the data center system according claim 9, wherein said control device releases allocation of said device in response to a release request from said plurality of nodes.

17. A reconfigurable node control method of a data center system, wherein in a data center system having a plurality of nodes, a reconfigurable node structured to be shared by said plurality of nodes and having at least one server including at least one device which executes processing in response to a processing request from said plurality of nodes
accepts a processing request from said plurality of nodes, and
allocates, in response to said processing request, processing corresponding to the processing request to said device of said server.

18. A computer-readable medium storing a program, wherein said program causes a reconfigurable node structured to be shared by a plurality of nodes of a data center system and having at least one server including at least one device which executes processing in response to a processing request from the plurality of nodes to execute the processing of:
accepting a processing request from said plurality of nodes; and
allocating, in response to said processing request, processing corresponding to the processing request to said device of said server.
